(19) United States
(12) Patent Application Publication
(10) Pub. No.: US 2012/0130918 A1
(43) Pub. Date: May 24, 2012

(54) System and Method for Complaint Submission and Management

(76) Inventor: Noam Gordon, Palo Alto, CA (US)

(21) Appl. No.: 13/299,257

(22) Filed: Nov. 17, 2011

Related U.S. Application Data
(60) Provisional application No. 61/458,122, filed on Nov. 18, 2010.

(51) Int. Cl. G06Q 30/00

(52) U.S. Cl. 705/347

(57) ABSTRACT

The disclosure is a system and method for filing complaints to a service provider, using a smartphone or similar connected wireless mobile device to create a specifically formatted record and post it publically on at least one of several social network sites such as Twitter or Facebook, using the site's API. The system may also make a follow up or other escalation of the complaint or send additional messages via non-public methods such as to a service provider CRM system as a way of managing and bringing about a resolution of the complaint.

### CROSS-REFERENCE TO RELATED APPLICATIONS

This application claims the benefit of U.S. Provisional Application No. 61/458,122, filed Nov. 18, 2010.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Consumers of various services and products often get good service. But, unfortunately, sometimes the service or product, even from large and reputable companies, does not measure up to the promises made. Unsuspecting consumers are often then left with “voicemail jail” to deal with attempts to get redress for a problem, and these systems are often designed to discourage consumers from reaching, in some cases from even being able to reach, redress.

### BRIEF SUMMARY OF THE INVENTION

What is needed is a system and method that enables people who have been treated badly by big large companies to complain quickly, via a social networking or communication application, such as, for example, including but not limited to Twitter, FourthSquare, Kik Messenger, Skype, Facebook, and LinkedIn, to follow up and get results and promote those results to praise responsive companies, and to associate with others who have the same complaints, while also providing administrators the ability elicit user comments and requests and to modify, adapt, and expand the user interface and functionality to meet expressed user needs and desires.

### BRIEF DESCRIPTION OF SEVERAL VIEWS OF THE DRAWING

FIG. 1 shows an overview a typical Smart Phone device 100 of the type currently used by many telephone customers. FIG. 2 shows a simplified overview of the architecture of a typical computer 200 as used in an Internet environment. FIG. 3 shows an overview of an exemplary system 300 according to one aspect of the system and method disclosed herein. FIG. 4 shows an exemplary process 400 for user interaction with the system according to one aspect of the system and method disclosed herein. FIG. 5 shows an exemplary process 500 for periodically checking responses to complaints according to one aspect of the system and method disclosed herein. FIG. 6a shows an exemplary process 600 for user interaction and subsequent analysis by the system of the success rate of a complaint based on the time it took to receive a positive answer from the company, according to one aspect of the system and method disclosed herein. FIG. 6b shows an exemplary process 650 that enables user 3 to select, in step 651, the text used to accomplish a successful complaint, and in step 652 to combine elements according to the user's most desired outcome.

### DETAILED DESCRIPTION OF THE INVENTION

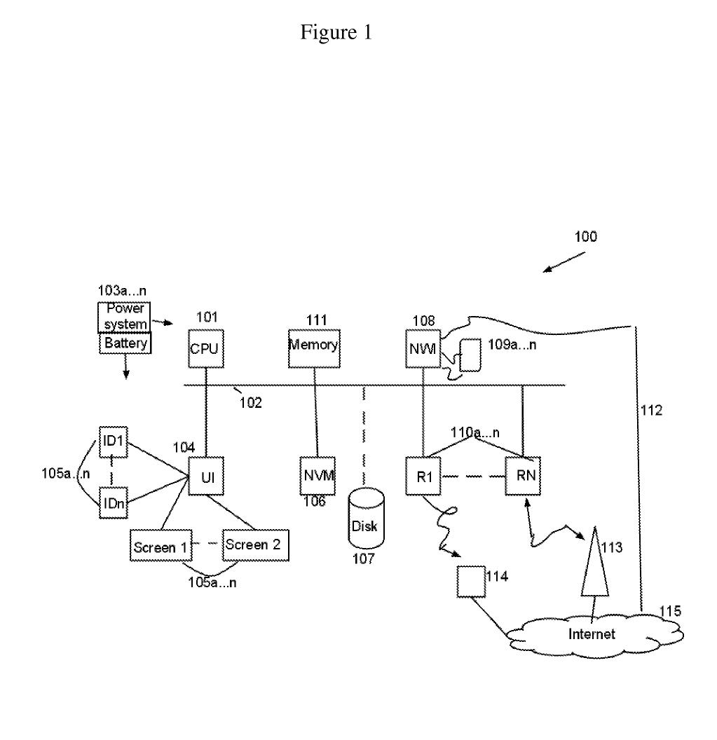

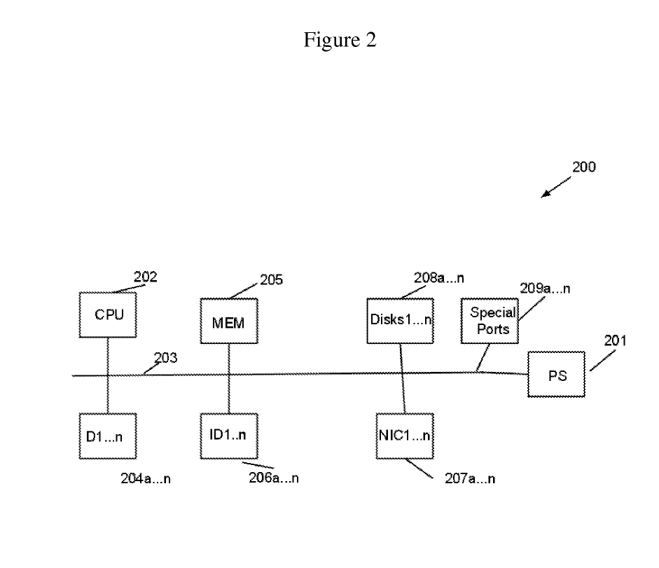

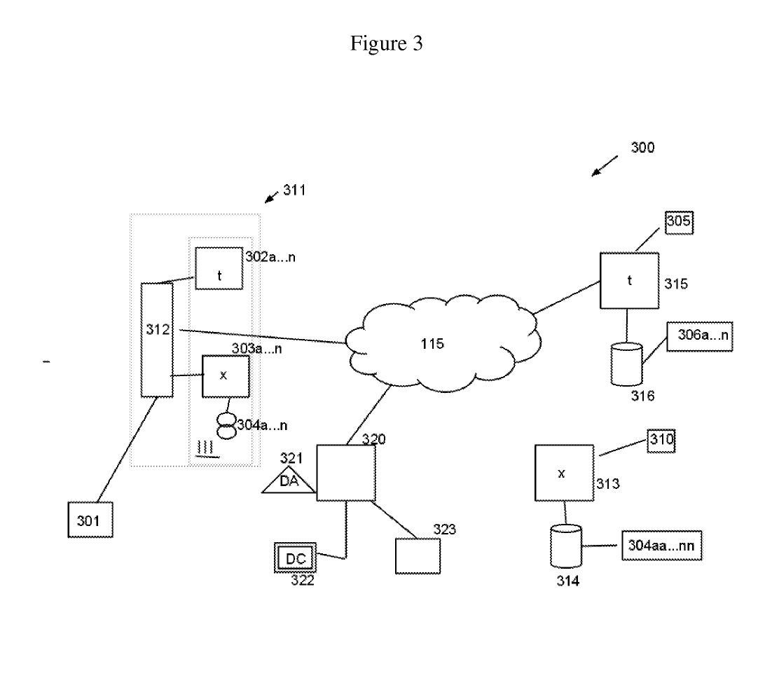

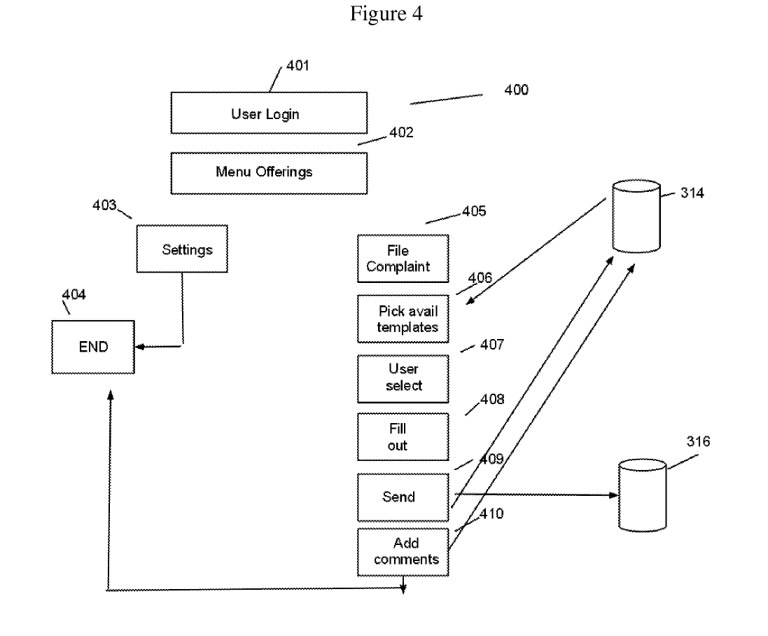

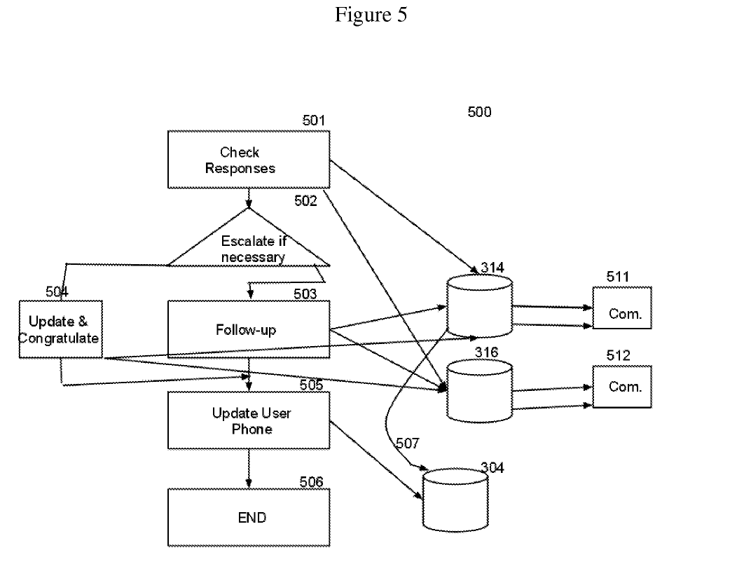

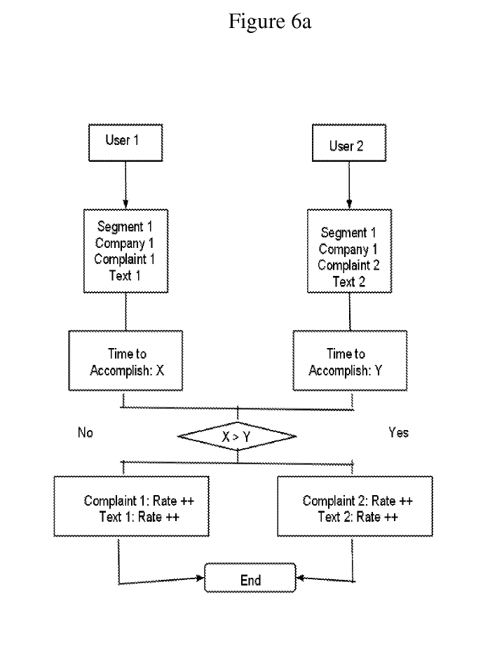

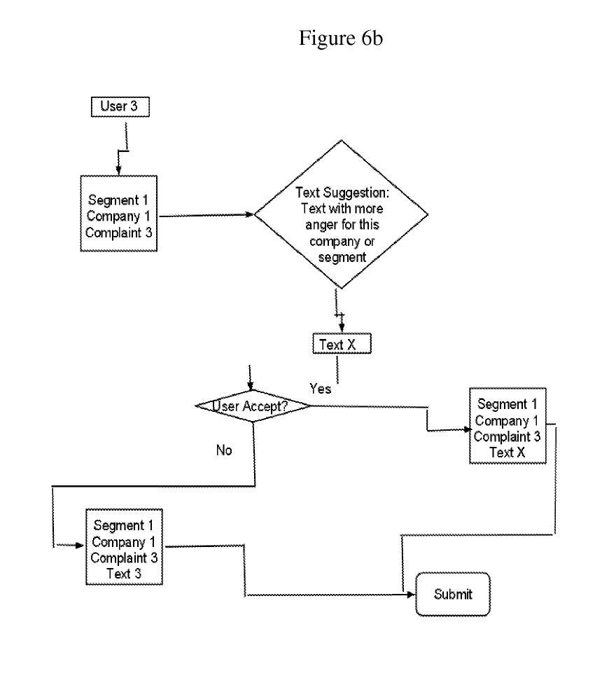

FIG. 1 shows an overview a typical Smart Phone device 100 of the type currently used by many telephone customers. Device 100 has a HCPU 101; a memory system 111; a bus 102; and a power system with battery 103a-n, which also may have charger circuits, etc., as needed. User interface system 104 has one or more input devices ID1 through IDn 105a-n and output devices or screens or display devices Screen 1 through Screen n 105a-n. In some cases, however, these output devices may be simple LEDs. Device 100 also has nonvolatile memory 106, in some cases a hard disk 107, one or more network interfaces 108 with multiple connectors 109a-n, and one or more radios R1 through Rn 110a-n, which may connect, for example, using one or more WAN interfaces, Bluetooth, wi-fi, etc. to the Internet 115. In this exemplary figure, R1 connects to a wi-fi hotspot 114 and Rn connects to WAN cell tower 113, with both interfaces then connecting to the Internet 115. In some cases, the local network interface may also connect through link 112 (often via computer) to the Internet.

FIG. 2 shows a simplified overview of the architecture of a typical computer 200 as used in an Internet environment. Computer 200 may be used as both a workstation and a server. It has a power supply 201, a CPU 202, a system bus 203 (many cases, computers may have many levels and types of buses, but for reasons of clarity and simplicity, only one representative bus is shown here), display devices D1 through Dn 204a-n, input devices ID1 through IDn 206a-n, disks 208a-n, network interfaces NIC1 through NICn 207a-n, and also additional special ports 209a-n. In some cases the disks may be USB disks connect via special USB port 209x. Computer 200 typically has such user interface devices as a keyboard and a pointing device, but for reasons of clarity and simplicity, these devices are included in the category of input devices 206a-n.

FIG. 3 shows an overview of an exemplary system 300 according to one aspect of the system and method disclosed herein. User device 311 is of the type described in the discussion of FIG. 1 as device 100. Core application 312 runs on CPU 101 (not shown here, but shown in FIG. 1). Additional specific modules 301 (there may be multiple such modules, not shown here), as well as data objects 302a-n, 303a-n, and 304a-n reside in memory 111. In this example, modules 302a-n interface with social networking and communication applications, such as, for example, the currently popular application called Twitter™, and modules 303a-n are the application of the system and method disclosed herein and its data objects 304a-n. Server 313 is the service provider for the present application according to the system and method disclosed herein, and server 315 is the server for Twitter or any other, similar social network or social communication system currently available (for purposes of clarity and simplicity, Twitter is used as a representative of any and all such applications). Data repository 316 is the repository for server 315 and data repository 314 is the repository for server 313. These repositories 314 and 316 contain, respectively, exemplary data objects 304aa-nn and 306a-n. Workstation 320 is of the type described in the discussion of FIG. 2 as computer 200. It has a monitor 321 and a keyboard 322, as well as other user interface devices, such as a pointing device, which are not shown here. Using a simple web browser 323, an administrator of the complaint management system as shown in FIG. 3 and throughout this document can log into server 313 and, using software 310, can administer the system as needed. An administrator can modify, adapt, and expand the user interface and functionality to meet expressed user needs and desires. For example, an administrator can build industry segments, such as, for example, Airlines, and within each segment, an administrator can create and modify lists of companies and can build complaint templates, such as, for example, Late Departure. An administrator can then associate templates with segments, reducing the need for building a complete set of templates for each segment, since some templates, such as, for example, Unresponsive Support Personnel, may be associated with any number of segments.

A user of the system, using core application 312 of the system, running on device 311, can issue a complaint about service via Twitter or some other, similar social networking or communication application, or multiple applications simultaneously. The system, which contains a database of companies and contact information, including a directory of customer service contacts on Twitter and other social networks, directs the user's complaint to the appropriate address according to the complaint. An exemplary initial user interface screen may have fields in similar to these, in the English language or other languages:

CompanyHash#, metatags, or other
Date when the problem happened
Where [list cities]

### Time

If the user chooses Other, the user can write their own complaint, limited to the number of characters specified by the particular application (e.g., 140 for Twitter) less the number of characters in the information already entered (company Twitter ID or other social networking or communication application ID , preset hash numbers (or other metatags), date, place (can be aided by GPS), time) as calculated by the system. Alternatively, the system may allow the user to enter unlimited text, in which case the complaint may include link to a web page that displays the entire complaint text, including any characters above the number of characters specified by the particular application. This will allow the user to provide complete details to the company they are complaining to. The user can also attach a picture, video or audio file that is related to the complaint (e.g., showing the filthy bathroom, the damaged suitcase, etc.) Users can suggest new templates, with may be added or adapted for certain segments. Users can also send a request to add a company to a particular segment. Alternatively, the system could enable users to add a company and its details to a segment. In some cases, the user could search for the company on Twitter to obtain company details. If the user doesn't know the Twitter address of the company, then the user can write a complaint. The system then saves the complaint until it obtains the company address. When the system adds the company, the complaint is submitted and the system notifies the user that the complaint has been submitted. The screen then displays sector-specific questions, using rules to decide which questions to ask for each specific sector, such as airlines/restaurants, PC makers, etc. For example, IF: Airline THEN: Flight #. The second screen shows predefined complaints by industry segment: For example, for the airline segment, choices may be: Late+how long, Bad check-in, Bumped, Lost luggage, Bad service, Safety, Other. The user may also be given the option to send the company a compliment, rather than a complaint. The third screen displays the whole complaint, showing the user how it looks and allowing the user to edit or add to the complaint. The user then clicks Submit or Back to return to a previous screen and modify any part of the complaint. Then the user may be asked to enter her details (name, email, social networking or communication application ID, etc.), or select social networking applications to which the complaint will be submitted, logging into those applications and linking them to the system, with an option such as “Keep information for my next complaint.” The complaint is then sent. After the complaint is sent, the user sees a note similar to this: “This complaint was sent via the ComplainAppiPhone app.” If the user has a Twitter account, the system should connect and send the complaint from the user's account. If the user does not have a Twitter account, the system offers to help the user set up a Twitter account, if possible. If the user doesn't want to set up a Twitter account, the system sends the complaint from its own account with the user's name attached. The system sends the complaint from all social networking accounts the user has connected to the service. After submission is complete, the user sees a message similar to this: “Great—you've submitted your complaint! Now you can relax and enjoy the rest of your day!” Such a message reinforces the benefit of the system to the user of releasing stress and frustration by offering instant satisfaction of sending a complaint. The system automatically groups complaints by company, type of complaint, geographic location, etc. and give users the option to view and ReTweet/re-post similar complaints, so that users with similar complaints or at similar locations can band together and increase the power of their individual voices. If the system determines that other users have complained about something similar, a message like this is also shown: “By the way, others have submitted similar complaints. Would you like to see their complaints? You can comment on them or ReTweet to show your support!” If yes, the system shows the user those complaints, with an option to comment or ReTweet next to each one. The system could ask users, after they submit a complaint, if they want to see similar complaints, and then they could view and filter complaints just like an administrator. The system could also designate some complaints as Promoted or Featured Complaints, and offer users the opportunity to pay using money or a point system to have their own complaints promoted. Promoted complaints would then be given priority display and would be more likely to be ReTweeted by other users. Users can also use the system to communicate and sympathize with each other about their complaints, reinforcing both the stress-release and the community support benefits of the system. The system then displays this message: “We'll follow up with you shortly via email to see if you've received an appropriate response. Add complaints@complaintsapp.com to your address book to be sure you get it.” Alternatively, the system communicates with the user using the system itself, the user's mobile phone, or the user's social networking accounts to notify the user when responses are received. The system could also, through its administrators or through the companies, offer users rebates and coupons for services, either for the company about which the complaint is submitted or for its competitors.

FIG. 4 shows an exemplary process 400 for user interaction with the system according to one aspect of the system and method disclosed herein. In step 401 the user logs into the system. The system may ask the user during or after login to provide additional credentials, such as his login information for Twitter or other, similar social network or communication application. The system may interact with various current social network or communication applications. Although, for purposes of clarity and simplicity, Twitter is used as a representative of any and all such applications, the system is not limited to interaction only with Twitter. In step 402 the user may request menu offerings, and the user may then select either the settings branch of the application or the file a complaint branch 405. If the user selects the settings branch, the system moves to step 403, where the user selects personalized settings, and then the process moves to step 404, where it terminates. If the user selects the file complaint branch 405, in step 406 the system downloads its available templates from repository 314. In step 407, the user selects a template. In step 408, the user fills in the fields of the template or modifies certain fields as allowed by the system. In step 409, the user submits the complaint. The system sends a copy of the complaint to data repository 314 and also sends the complaint to the data repository 316 of the organization(s) or enterprise(s) specified by the user in the complaint template through the API of one or several social networking or communication applications. The complaint is published from data repository 316 and the user who generated the complaint is also notified of its publication. In the step 410 the system offers the user the opportunity to add additional comments about the usability of the template or other aspects of the system. These comments are stored in data repository 314, from which a system administrator may review them and modify the application templates or other aspects of the system accordingly. The system is constantly analyzing complaint text and optimizing success results based on companies' responses and how successfully the complaint is resolved.

FIG. 5 shows an exemplary process 500 for periodically checking responses to complaints according to one aspect of the system and method disclosed herein. In step 501 the system checks for responses to all open cases of filed complaints. In step 502 the system elects whether to escalate the complaint or not. If the complaint has received a satisfactory response, the process moves to step 504, where the system updates case records, both in its own data repository 314 and the data repository 316 of the social network via which the complaint was sent. The system also sends a congratulatory message to the user who filed the complaint via the relevant API and to the company the user has complained about. If no response to the complaint has been received, in step 503 the system presents follow-up options to the user and generates messages prompting the company to respond. The user's response is also published to data repositories 314 and 316 of servers 313 and 315. The servers in turn use their own communication systems, respectively 511 and 512, to send out messages via email, fax, printed hard copy mail, or even human calls to the complaint recipient. Human calls could be, in some cases, implemented by contracting with a call center whose operators would then call to file complaints on behalf of the user. In step 505 the system sends an update of follow-up actions to the user's phone, shown as local telephone repository 304. Once the complaint has been answered and resolved to the user's satisfaction, they system sends out a congratulatory message to the company and prompts the user to do the same. In step 506 the process ends.

FIG. 6a shows an exemplary process 600 for user interaction and subsequent analysis by the system of the success rate of a complaint based on the time it took to receive a positive answer from the company, according to one aspect of the system and method disclosed herein. User 1 601 and User 2 602 each submit a complaint 603 and 604, respectively, about Company 1 in industry Segment 1. User 1, however, submits Complaint 1, comprising Text 1; while User 2 submits Complaint 2, comprising Text 2. In step 605 the system tracks how long (Time to Accomplish) the complaint 603 of User 1 601 required to accomplish X, where X is a desired outcome, for example a full refund; and, similarly, in step 606 the system tracks how long (Time to Accomplish) the complaint 604 of User 1 602 required to accomplish Y, where Y is User 2's desired outcome. At step 607, the system compares the two times of steps 605 and 606, as well as other aspects, such as values of X vs. Y, additional interactions required etc. Based on a weighted result of the comparison at step 607, each of the outcomes is noted in steps 608 and 609, respectively, enabling a rating of certain complaints based on their outcome and of companies based on their responsiveness. Even though this is a very simplistic example, it is clear that many more than just two complaints can be compared, and that many more parameters can be used for calculating the outcome, along the lines of a multi-variate analysis (MVA), enabling the system to track and compare many variables, and hence to determine the most useable complaint text/form based on a desired outcome and to possibly rate companies according to a point system for speed of response, user satisfaction, etc. For example, one user may prefer a quick resolution, whereas another may prefer to maximize his compensation, etc.

FIG. 6b shows an exemplary process 650 that enables user 3 to select, in step 651, the text used to accomplish a successful complaint, and in step 652 to combine elements according to the user's most desired outcome. In step 653 the system checks the chances of success using one or more of the aspects discussed in the description of FIG. 6a, above, and throughout. Then in step 654 the system offers an alternate Text X. The user can then approve the new text (Yes) and a new complaint using Text X is formed in step 656 and then submitted in step 658. If the user decides No, a complaint is formed in step 657 and is then submitted in step 658 as well. This complaint is added to the library of complaint texts, and the outcome is tracked as described above, so future users could be advised to use this format. This process also checks the company and/or the sector of the complaint, so it is relevant for that environment. Additional filters may be employed to mask out phone numbers, email addresses and membership/account IDs, etc. Also, in some cases, that information may be transmitted in the CRM message, email etc., but not in the published social networking post, etc.

It is clear that many modifications and variations of the system and method disclosed herein may be made by one skilled in the art without departing from the spirit of the novel art of this disclosure. For example, an application may be launched on a SmartPhone or similar connected wireless mobile device, which application may assist a user in creating a complaint formatted in a specific way according to a template, and then the complaint may be filed by posting it on at least one of several social network sites, such as, for example, Twitter. In some cases, the complaint may be posted publicly. Additionally, the system may follow up to check whether a reply was received, and if no satisfactory response is received by a pre-defined deadline, the complaint may be escalated, by, for example including but not limited to re-sending the complaint, sending an additional message to the company, emailing, filling out of web forms, faxes, printed letters sent by regular mail etc. In some cases, the system may offer companies direct connectivity of their Customer Relationship Management (CRM) system, available as standard software to operate on computers, or brand management system/DB to the system, for easier management from their side, and for receiving data more comfortably and privately, rather than publicly. In addition, companies may have the option of adding a connection or component to their websites that would give their customers direct connectivity to the system. Companies wishing to receive complaints privately may need to meet a predetermined level of service/standards and or a willingness to reasonably redress customers' complaints. These modifications and variations do not depart from its broader spirit and scope, and the examples cited here are to be regarded in an illustrative rather than a restrictive sense.

1. A method for filing complaints to a service provider, wherein an application is launched on a Smartphone or similar connected wireless mobile device, and wherein the application assists the user in creating a record formatted in a specific way according to a template, and said complaint is filed by posting it on at least one of several social network sites.

2. As in claim 1, wherein it is posted publicly

3. As in claim 1 or 2, wherein at least one of the services is Twitter

4. As in claim 1 or 2, wherein at least one of the services is Facebook

5. As in claim 1, 2, 3 or 4, wherein a follow up is made to check whether a reply was received

6. As in claim 5, wherein an escalation is made, when no satisfactory response is received by a pre-defined deadline

7. As in claims 1-6, wherein additional, non-public messages are sent in parallel containing private user data.

8. As in claims 1-7, wherein such messages will be sent to a CRM system

9. As claims 1-8, a system for implementing said methods, wherein a SmartPhone device communicates with a server to obtain certain information, and then posts that in combination with user information to at least one social networking site, using that site's API
